(19) United States
(12) Patent Application Publication
(10) Pub. No.: US 2005/0270419 A1
(43) Pub. Date: Dec. 8, 2005

(54) Unit for and method of image conversion

(75) Inventor: Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC N.V., Eindhoven (NL)

(21) Appl. No.: 10/530,376

(22) PCT Filed: Sep. 17, 2003
(86) PCT No.: PCT/IB03/04151

§ 371 Date: Apr. 6, 2005

(30) Foreign Application Priority Data
Oct. 11, 2002 (EP) 020792156

(51) Int. Cl. H04N 7/01

(52) U.S. Cl. 348/458

(57) ABSTRACT

An image conversion unit (200) for converting a first input image with a first resolution into an output image with a second resolution, comprises a coefficient-determining means (106) for determining a first filter coefficient on basis of pixel values of the first input image. The coefficient-determining means (106) is arranged to control an adaptive filtering means (104) for calculating a pixel value of the output image on basis of an input pixel value of the first image and the first filter coefficient. The adaptive filtering means (104) is arranged to perform a non-linear operation.

The invention relates to an image conversion unit for converting a first image with a first resolution into a second image with a second resolution, the image conversion unit comprising:

a coefficient-determining means for determining a first filter coefficient on basis of pixel values of the first image;

an adaptive filtering means for calculating a second pixel value of the second image on basis of a first one of the pixel values of the first image and the first filter coefficient.

The invention further relates to a method of converting a first image with a first resolution into a second image with a second resolution, the method comprising:

a step of determining a first filter coefficient on basis of pixel values of the first image;

a step of calculating a second pixel value of the second image on basis of a first one of the pixel values of the first image and the first filter coefficient.

The invention further relates to an image processing apparatus comprising:

receiving means for receiving a signal corresponding to the first image; and

the above mentioned image conversion unit for converting the first image into a second image.

The advent of HDTV emphasizes the need for spatial up-conversion techniques that enable standard definition (SD) video material to be viewed on high definition (HD) television (TV) displays. Conventional techniques are linear interpolation methods such as bi-linear interpolation and methods using poly-phase low-pass interpolation filters. The former is not popular in television applications because of its low quality, but the latter is available in commercially available ICs. With the linear methods, the number of pixels in the frame is increased, but the high frequency part of the spectrum is not extended, i.e. the perceived sharpness of the image is not increased. In other words, the capability of the display is not fully exploited.

Additional to the conventional linear techniques, a number of non-linear algorithms have been proposed to achieve this up-conversion. Sometimes these techniques are referred to as content-based or edge dependent spatial up-conversion. Some of the techniques are already available on the consumer electronics market.

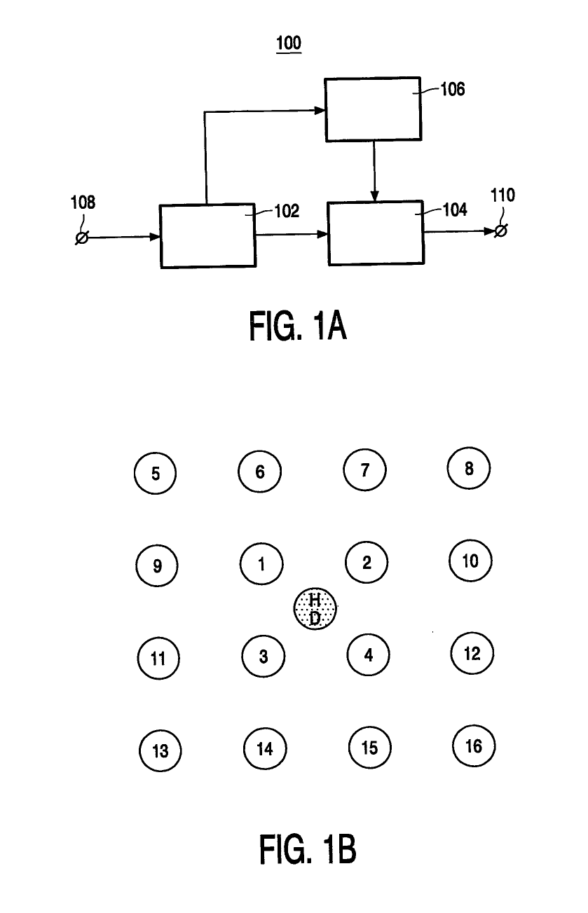

An embodiment of the image conversion unit of the kind described in the opening paragraph is known from the article “sew Edge-Directed Interpolation”, by Xin Li et al., in IEEE Transactions on Image Processing, Vol. 10, No 10, October 2001, pp. 1521-1527. In this image conversion unit, the filter coefficients of an interpolation up-conversion filter are adapted to the local image content. The interpolation up-conversion filter aperture uses a fourth order interpolation algorithm as specified in Equation 1:

$${F}_{HD} ( 2 ( i + 1 ) , 2 ( j + 1 ) ) = {\sum }_{k = 0}^{1} {\sum }_{l = 0}^{1} {w}_{2 k + 1} {F}_{SD} ( 2 i + 2 k , 2 j + 2 l ) \qquad ( 1 )$$

where F_{HD} (i, j) denotes the luminance values of the HD output pixels, F_{SD} (i, j) the luminance values of the input pixels and wᵢ the filter coefficients. The filter coefficients are obtained from a larger aperture using a Least Mean Squares (LMS) optimization procedure. In the cited article is explained how the filter coefficients are calculated. The method according to the prior art is also explained in connection with FIG. 1A and FIG. 1B. The method aims at interpolating along edges rather than across them to prevent blurring. The authors make the sensible assumption that edge orientation does not change with scaling. Therefore, the coefficients can be approximated from the SD input image within a local window by using the LMS method.

Although the “New Edge-Directed Interpolation” method according to the cited prior art works relatively well in many image parts, in some parts of the output image there are pixel values which are relatively high or low compared with the pixel values in their direct neighborhood, i.e. these pixel values can be interpreted as outliers.

It is an object of the invention to provide an image conversion unit of the kind described in the opening paragraph, which is relatively robust.

This object of the invention is achieved in that the adaptive filtering means is arranged to perform a non-linear operation. That means that the adaptive filtering means does not fulfil the requirements for a linear filter G as specified in Equation 2 and 3.
αG(A)=G(αA) (2)
G(A)+G(B)=G(A+B) (3)
With A and B input values and a a constant.

An advantage of the non-linear operation is that more freedom is introduced in selecting filter coefficients without having the risk that the resulting pixel values of the output pixels are outliers. In other words, the robustness of the conversion unit is increased.

Typically the SD input images have pixel matrices as specified in CCIR-601, e.g. 625*720 pixels or 525*720 pixels. The HD output images have pixel matrices with a higher, e.g. twice or one-and-a-halve times, number of pixels in horizontal and vertical direction.

With pixel value is meant a luminance or color value.

In an embodiment according to the invention the non-linear operation comprises clipping an intermediate value on basis of the first one of the pixel values. For example an HD output pixel value is clipped between the darkest, i.e. lowest luminance value, and brightest, i.e. highest luminance value, of the nearest neighboring SD pixels or in a somewhat larger range depending on the dynamic range of the pixel value in the neighborhood. An advantage of clipping is that it is relatively easy to implement.

In another embodiment according to the invention the adaptive filtering means comprises an order statistical filter. This might be a differential order statistical filter. An example of an order statistical filter is a median filter.

In another embodiment according to the invention the coefficient-determining means comprises a translating means for translating data being derived from pixel values in a neighborhood of the first one of the pixel values into the first filter coefficient, the translating means being designed on basis of a training process. An advantage of this embodiment is that the determining of the filter coefficient requires a relatively low computing resources usage. Preferably the translating means comprises a Look-Up-Table (LUT). An approach of applying a LUT for determining filter coefficients in the case of an up-conversion unit is disclosed in the article “Towards an overview of spatial up-conversion techniques”, by Meng Zhao et al., in the proceedings of the SCE 2002, Erffit, Germany, 23-26 Sep. 2002.

In an embodiment of the image conversion unit according to the invention the coefficient-calculating means is arranged to calculate the first filter coefficient by means of an optimization algorithm. Preferably the optimization algorithm is a Least Mean Square algorithm. An LMS algorithm is relatively simple and robust.

It is a further object of the invention to provide a method of the kind described in the opening paragraph which is relatively robust.

This object of the invention is achieved in that the step of calculating the second pixel value comprises a non-linear operation.

It is a further object of the invention to provide an image processing apparatus of the kind described in the opening of which the image conversion unit is relatively robust.

This object of the invention is achieved in that the adaptive filtering means of the image processing apparatus is arranged to perform a non-linear operation. The image processing apparatus optionally comprises a display device for displaying the second image. The image processing apparatus might e.g. be a TV, a set top box, a VCR (Video Cassette Recorder) player or a DVD (Digital Versatile Disk) player.

Modifications of image conversion unit and variations thereof may correspond to modifications and variations thereof of the method and of the image processing apparatus described.

These and other aspects of the image conversion unit, of the method and of the image processing apparatus according to the invention will become apparent from and will be elucidated with respect to the implementations and embodiments described hereinafter and with reference to the accompanying drawings, wherein:

FIG. 1A schematically shows an embodiment of the image conversion unit according to the prior art;

FIG. 1B schematically shows a number of pixels to explain the method according to the prior art;

FIG. 1C schematically shows an alternative embodiment of the image conversion unit according to the prior art;

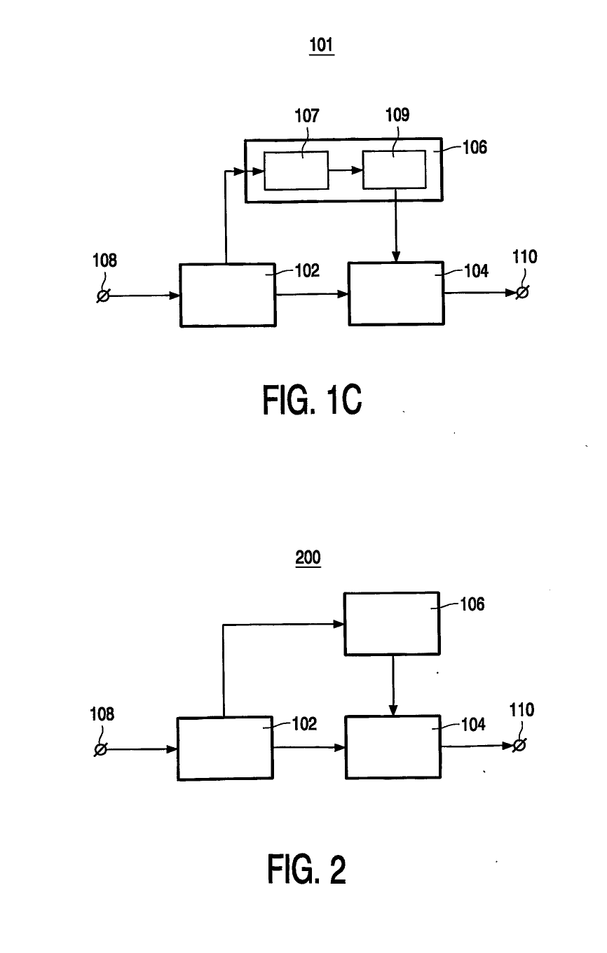

FIG. 2 schematically shows an embodiment of the image conversion unit according to the invention;

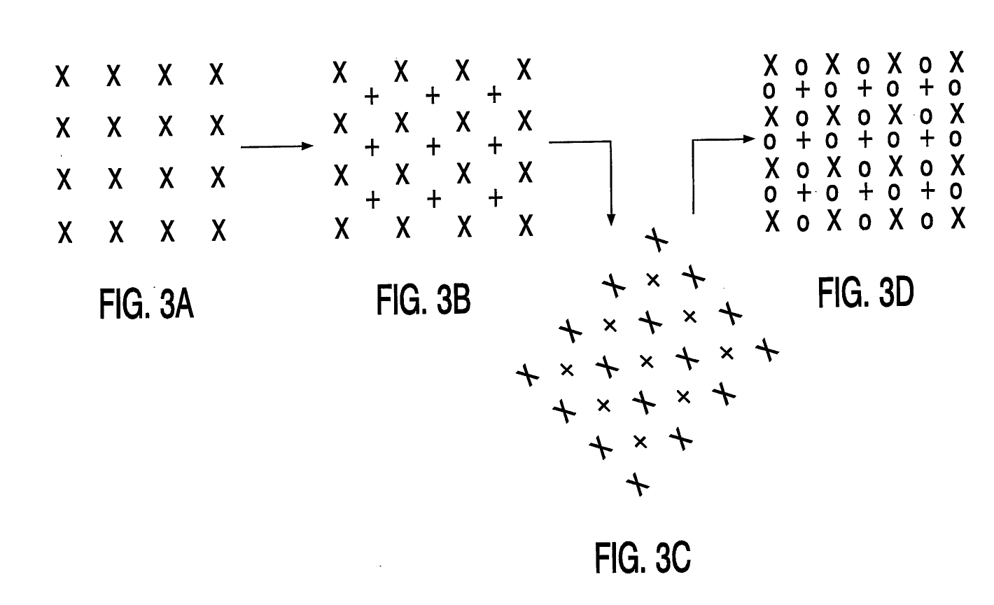

FIG. 3A schematically shows an SD input image;

FIG. 3B schematically shows the SD input image of FIG. 3A on which pixels are added in order to increase the resolution;

FIG. 3C schematically shows the image of FIG. 3B after being rotated over 45 degrees;

FIG. 3D schematically shows an HD output image derived from the SD input image of FIG. 3A; and

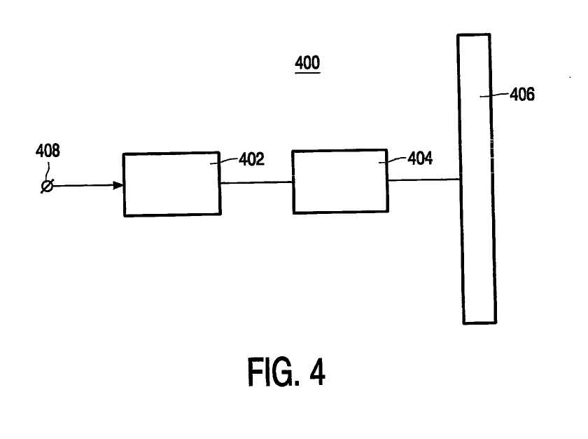

FIG. 4 schematically shows an embodiment of the image processing apparatus according to the invention.

Same reference numerals are used to denote similar parts throughout the figures.

FIG. 1A schematically shows an embodiment of the image conversion unit 100 according to the prior art. The image conversion unit 100 is provided with standard definition (SD) images at the input connector 108 and provides high definition (HD) images at the output connector 110. The image conversion unit 100 comprises:

A pixel acquisition unit 102 which is arranged to acquire a first set of pixel values of pixels 1-4 (See FIG. 1B) in a first neighborhood of a particular location within a first one of the SD input images which corresponds with the location of an HD output pixel and is arranged to acquire a second set of pixel values of pixels 1-16 in a second neighborhood of the particular location within the first one of the SD input images;

A filter coefficient-determining unit 106, which is arranged to calculate filter coefficients on basis of the first set of pixel values and the second set of pixel values. In other words, the filter coefficients are approximated from the SD input image within a local window. This is done by using a Least Mean Squares (LMS) method which is explained in connection with FIG. 1B.

An adaptive filtering unit 104 for calculating the pixel value of the HD output pixel on basis of the first set of pixel values and the filter coefficients as specified in Equation 1. Hence the filter coefficient-determining unit 106 is arranged to control the adaptive filtering unit 104.

FIG. 1B schematically shows a number of pixels 1-16 of an SD input image and one HD pixel of an HD output image, to explain the method according to the prior art. The HD output pixel is interpolated as a weighted average of 4 pixel values of pixels 1-4. That means that the luminance value of the HD output pixel F_{HD} results as a weighted sum of the luminance values of its 4 SD neighboring pixels:
F_{HD}=ω₁F_{SD}(1)+w₂F_{SD}(2)+w₃F_{SD}(3)+w₄F_{SD}(4), (4)
where F_{SD} (1) to F_{SD}(4) are the pixel values of the 4 SD input pixels 1-4 and w₁ to w₄ are the filter coefficients to be calculated by means of the LMS method. The authors of the cited article in which the prior art method is described, make the sensible assumption that edge orientation does not change with scaling. The consequence of this assumption is that the optimal filter coefficients are the same as those to interpolate, on the standard resolution grid:

Pixel 1 from 5, 7, 11, and 4 (that means that pixel 1 can be derived from its 4 neighbors)

Pixel 2 from 6, 8, 3, and 12

Pixel 3 from 9, 2, 13, and 15

Pixel 4 from 1, 10, 14, and 16

This gives a set of 4 linear equations from which with the LSM-optimization the optimal 4 filter coefficients to interpolate the HD output pixel are found.

Denoting M as the pixel set, on the SD-grid, used to calculate the 4 weights, the Mean Square Error (MSE) over set M in the optimization can be written as the sum of squared differences between original SD-pixels F_{SD} and interpolated SD-pixels F_{SI}:

$$MSE = {\sum }_{{F}_{SD ( l , j ) εM}} {( {F}_{SD} ( 2 i + 2 , 2 j + 2 ) - {F}_{SI} ( 2 i + 2 , 2 j + 2 ) )}^{2} \qquad ( 5 )$$

Which in matrix formulation becomes:
MSE=∥\vec{y}−\vec{w}C∥² (6)
Here \vec{y} contains the SD-pixels in M (pixel F_{SD}(1,1) to F_{SD}(1,4), F_{SD}(2,1) to F_{SD}(2,4), F_{SD}(3,1) to F_{SD}(3,4), F_{SD}(4,1) to F_{SD}(4,4) and C is a 4×M² matrix whose k^{th} row contains the four diagonal SD-neighbors of the k^{th} SD-pixels in \vec{y}. The weighted sum of each row describes a pixel F_{SI}, as used in Equation 5. To find the minimum MSE, i.e. LMS, the derivation of MSE over \vec{w} is calculated:

$$\begin{matrix}\frac{\partial ( MSE )}{\partial \vec{w}} = 0 & ( 7 ) \\ - 2 \vec{y} C + 2 \vec{w} {C}^{2} = 0 & ( 8 ) \\ \vec{w} = {( {C}^{T} C )}^{- 1} ( {C}^{T} \vec{y} ) & ( 9 )\end{matrix}$$

By solving Equation 7 the filter coefficients are found and by using Equation 4 the pixel values of the HD output pixels can be calculated.

In this example a window of 4 by 4 pixels is used for the calculation of the filter coefficients. An LMS optimization on a larger window, e.g. 8 by 8 instead of 4 by 4 gives better results.

FIG. 1C schematically shows an alternative embodiment of the image conversion unit 101 according to the prior art. The filter coefficient-determining unit 106 comprises a compression unit 107 and a LUT 109 with data being derived during a training process. A compression scheme is based on detecting which of the pixels in a sliding window are above and which of the pixels in the window are below the average luminance value of the pixels in the window. This results for every position of the sliding window a pattern of zeros (pixel values below the average luminance value) and ones (pixel values above the average luminance value). This pattern corresponds with an entry of the LUT 109. At the respective output of the LUT 109 the appropriate filter coefficients are provided for the given input. In the article “Towards an overview of spatial up-conversion techniques”, by Meng Zhao et al., in the Proceedings of the ISCE 2002, Erfurt, Germany, 23-26 Sep. 2002, this embodiment of the image conversion unit 101 according to the prior art is explained further.

FIG. 2 schematically shows an embodiment of the image conversion unit 200 according to the invention. This image conversion unit 200 basically comprises the same type of components as the image conversion units 100 and 101 as described in connection with FIG. 1A and FIG. 1C, respectively. A difference is the fact that the adaptive filtering unit 104 is arranged to perform a non-linear operation. Optionally the coefficient-determining unit 106 is arranged to determine filter coefficients by taking into account that the adaptive filtering unit is arranged to perform a non-linear operation. That means that there are additional constraints for determining the filter coefficients.

By means of numerical examples the various types of non-linear operations will be explained below. In these examples F_{SD}(i) corresponds with the pixel value of an SD input pixel, Wᵢ corresponds with a non-normalized filter coefficient and F_{HD} is the pixel value of the HD output pixel.

In the case of linear interpolation the pixel value the HD output pixel can be calculated by means of Equation 4. This Equation can be rewritten for non-normalized filter coefficients into Equation 10:

$${F}_{HD} = \frac{{W}_{1} {F}_{SD} ( 1 ) + {W}_{2} {F}_{SD} ( 2 ) + {W}_{3} {F}_{SD} ( 3 ) + {W}_{4} {F}_{SD} ( 4 )}{{W}_{1} + {W}_{2} + {W}_{3} + {W}_{4}} \qquad ( 10 )$$

In Table 1 some examples are given for F_{SD}(i), Wᵢ and F_{HD} according to Equation 10.

TABLE 1
Linear interpolation:

| F_{SD}(1) | W₁ | F_{SD}(2) | W₂ | F_{SD}(3) | W₃ | F_{SD}(4) | W₄ | F_{HD} |
|---|---|---|---|---|---|---|---|---|
| 10 | 1 | 15 | 1 | 8 | 1 | 11 | 1 | 11 |
| 10 | 3 | 15 | 2 | 8 | 1 | 11 | 4 | 11.2 |
| 10 | 1 | 15 | 1 | 8 | −1 | 11 | −2 | 5 |
| 10 | 1 | 15 | 3 | 8 | −2 | 11 | 1 | 16.667 |

In an embodiment according to the invention the adaptive filtering unit 104 is arranged to clip the pixel value of the HD output pixel between the values of the SD input pixels on basis of which the HD is interpolated. Table 2 provides some examples that are derived from Table 1. Comparing the fourth row of Table 1 with the fourth row of Table 2 it can be seen that the value of the HD output pixel is clipped to the lowest value, i.e. 8 of the values 10, 15, 8, 11 of the SD input pixels. Comparing the fifth row of Table 1 with the fifth row of Table 2 it can be seen that the value of the HD output pixel is clipped to the highest value 15 of the values 10, 15, 8, 11 of the SD input pixels.

TABLE 2
Linear interpolation with clipping.

| F_{SD}(1) | W₁ | F_{SD}(2) | W₂ | F_{SD}(3) | W₃ | F_{SD}(4) | W₄ | F_{HD} |
|---|---|---|---|---|---|---|---|---|
| 10 | 1 | 15 | 1 | 8 | 1 | 11 | 1 | 11 |
| 10 | 3 | 15 | 2 | 8 | 1 | 11 | 4 | 11.2 |
| 10 | 1 | 15 | 1 | 8 | −1 | 11 | −2 | 8 |
| 10 | 1 | 15 | 3 | 8 | −2 | 11 | 1 | 15 |

In another embodiment according to the invention the adaptive filtering unit 104 is arranged to determine a weighted median value as output pixel value. In Table 3 the input and output values are listed.

TABLE 3
Weighted median value

| F_{SD}(1) | W₁ | F_{SD}(2) | W₂ | F_{SD}(3) | W₃ | F_{SD}(4) | W₄ | F_{HD} |
|---|---|---|---|---|---|---|---|---|
| 10 | 4 | 15 | 3 | 8 | 5 | 11 | 1 | 10 |

In this case the weighted median value is determined by creating a set S of values on basis of the pixel values and the respective filter coefficients. For instance the filter coefficient for the first pixel with pixel value being equal to 10 is 4. Then this pixel value is present 4 times in the set S. The pixel value 15 is present 3 times in the set S. The weighted median value is determined by sorting the elements of the set S, and subsequently taking the middle element of the ordered set. Thus
S={8,8,8,8,8,10,10,10,10,11,15,15,15} and F_{SD}=10

The pixel acquisition unit 102, the filter coefficient-determining unit 106 and he adaptive filtering unit 104 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

To convert an SD input image into an HD output image a number of processing steps are needed. By means of FIGS. 3A-3D these processing steps are explained. FIG. 3A schematically shows an SD input image; FIG. 3D schematically shows an HD output image derived from the SD input image of FIG. 3A and FIGS. 3B and 3C schematically show intermediate results.

FIG. 3A schematically shows an SD input image. Each X-sign correspond with a respective pixel.

FIG. 3B schematically shows the SD input image of FIG. 3A on which pixels are added in order to increase the resolution. The added pixels are indicated with +-signs. These added pixels are calculated by means of interpolation of the respective diagonal neighbors. The filter coefficients for the interpolation are determined as described in connection with FIG. 2B.

FIG. 3C schematically shows the image of FIG. 3B after being rotated over 45 degrees. The same image conversion unit 200 as being applied to calculate the image as depicted in FIG. 3B on basis of FIG. 3A can be used to calculate the image as shown in FIG. 3D on basis of the image as depicted in FIG. 3B. That means that new pixel values are calculated by means of interpolation of the respective diagonal neighbors. Notice that a first portion of these diagonal neighbors (indicated with X-signs) correspond to the original pixel values of the SD input image and that a second portion of these diagonal neighbors (indicated with +-signs) correspond to pixel values which have been derived from the original pixel values of the SD input image by means of interpolation.

FIG. 3D schematically shows the final HD output image. The pixels that have been added in the last conversion step are indicated with o-signs.

FIG. 4 schematically shows an embodiment of the image processing apparatus 400 according to the invention, comprising:

Receiving means 402 for receiving a signal representing SD images. The signal may be a broadcast signal received via an antenna or cable but may also be a signal from a storage device like a VCR (Video Cassette Recorder) or Digital Versatile Disk (DVD). The signal is provided at the input connector 408;

The image conversion unit 404 as described in connection with FIG. 2B; and

A display device 406 for displaying the HD output images of the image conversion unit 200. This display device 406 is optional.

The image processing apparatus 400 might e.g. be a TV. Alternatively the image processing apparatus 400 does not comprise the optional display device but provides HD images to an apparatus that does comprise a display device 406. Then the image processing apparatus 400 might be e.g. a set top box, a satellite-tuner, a VCR player or a DVD player. But it might also be a system being applied by a film-studio or broadcaster.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. An image conversion unit for converting a first image with a first resolution into a second image with a second resolution, the image conversion unit comprising:
a coefficient-determining means for determining a first filter coefficient on basis of pixel values of the first image;
an adaptive filtering means for calculating a second pixel value of the second image on basis of a first one of the pixel values of the first image and the first filter coefficient, characterized in that the adaptive filtering means is arranged to perform a non-linear operation.

2. An image conversion unit as claimed in claim 1, characterized in that the non-linear operation comprises clipping an intermediate value on basis of the first one of the pixel values.

3. An image conversion unit as claimed in claim 1, characterized in that the adaptive filtering means comprises an order statistical filter.

4. An image conversion unit as claimed in claim 3, characterized in that the order statistical filter is a differential order statistical filter.

5. An image conversion unit as claimed in claim 3, characterized in that the order statistical filter is a median filter.

6. An image conversion unit as claimed in claim 1, characterized in that the coefficient-determining means comprises a translating means for translating data being derived from pixel values in a neighborhood of the first one of the pixel values into the first filter coefficient, the translating means being designed on basis of a training process.

7. An image conversion unit as claimed in claim 6, characterized in that the translating means comprises a Look-Up-Table.

8. An image conversion unit as claimed in claim 1, characterized in that the coefficient-calculating means is arranged to calculate the first filter coefficient by means of an optimization algorithm.

9. A method of converting a first image sequence, comprising a first image with a first resolution and a second image with the first resolution into a second image sequence comprising a third image with a second resolution, the method comprising:
a step of determining a first filter coefficient on basis of pixel values of the first image;
a step of calculating a second pixel value of the second image on basis of a first one of the pixel values of the first image and the first filter coefficient, characterized in that the step of calculating the second pixel value comprises a non-linear operation.

10. An image processing apparatus comprising:
receiving means for receiving a signal corresponding to a first image; and
the image conversion unit for converting the first image into a second image, as claimed in claim 1.

11. An image processing apparatus as claimed in claim 10, characterized in further comprising a display device (406) for displaying the second image.

12. An image processing apparatus as claimed in claim 11, characterized in that it is a TV.
